(19) United States
(12) Patent Application Publication
(10) Pub. No.: US 2018/0318053 A1
(43) Pub. Date: Nov. 8, 2018

(54) BLANK AND METHOD FOR PRODUCING A DENTAL RESTORATION WITH PARTITION SEGMENT AND RESTORATION SEGMENT

(71) Applicant: QUARZ PARTNERS AG, Zurich (CH)

(72) Inventor: Werner Hans MÖRMANN, Zurich (CH)

(21) Appl. No.: 15/764,930

(22) PCT Filed: Jun. 30, 2016
(86) PCT No.: PCT/CH2016/000098

§ 371 Date: Mar. 30, 2018

(30) Foreign Application Priority Data
Nov. 26, 2015 (CH) 1730/15

(51) Int. Cl. A61C 13/00

(52) U.S. Cl. CPC A61C 13/0022; A61C 2201/002; A61C 13/0006; A61C 13/0004

(57) ABSTRACT

The blank has a restoration segment (4), a holder (2), and a partition segment (3) that connects the holder (2) to the restoration segment (4). The material of the partition segment (3) visually differs from that of the restoration segment (4). In preparation for machining, in the context of CAD/CAM machining, the outer shape of the workpiece (6) to be produced is fitted into the restoration segment (4) such that a smooth surface of the outer shape comes to lie in the interface plane (5) between the segments. The blank is then worked mechanically in order to create the outer shape. A partition pin (3b, 3c) remains between the holder (2) and the restoration segment (4) and is removed. A partition-pin-base (13) remaining in the restoration segment (4) can then be removed manually. A color marker simplifies this work step.

### FIELD OF THE INVENTION

The invention relates to a blank for manufacturing a dental restoration by means of automated abrasive machining in a machining device as well as to a method for machining such a blank according to the preamble of the independent claims. The invention also relates to a machining device for carrying out this method.

### BACKGROUND

The maintenance of teeth by means of CAD/CAM restorations is a demanding work, which, in 2015, 30 years after its first application on a patient, has developed into a highly precise method in the restorative and prosthetic art of dental care.

A conventional blank block for a dental CAD/CAM system has been known from EP160797. Such blank blocks are, for example, processed in the Cerec CAD/CAM method (see EP0054785) in the devices of the company Sirona Dental Systems (Bensheim, Germany; http://www.sirona.com). The blanks consist of different restoration materials and are used in different sizes, in particular for restoring teeth with inlays, onlays, partial and full crowns for anterior and posterior teeth, and veneers, but they are also used for manufacturing of bridges, bridge constructions, bridge veneers, temporary bridges, abutments etc. (Ender and Mehl, Cerec Basiswissen 3.80; ein klinischer Leitfaden, www.cerec.uzh.ch/). Blanks of this type are, for example, manufactured by the companies VITA Zahnfabrik (www.vita-zahnfabrik.de) and Ivoclar Vivadent (ivoclarvivadent.com).

During the design of restorations, the conventional CAD application suggests a location for the separating point on one of the exterior surfaces of the restoration. For inlays, for example, the separating point is placed on a smooth surface, namely on the proximal surface of an inlay. The milling process starts, after calibrating the grinding tools on the block holder and on the block itself, at the free end of the blank, and it ends with a partition pin having a cross section of approximately 2×3 mm and a length of 1 to 3 mm, which connects the restorative workpiece to the rest of the block. If the partition pin is further milled towards its axis, it breaks, and its stub remains on the proximal surface of the otherwise finished workpiece. This procedure is e.g. of particular disadvantage if the location of separation projects by approximately 1 to 2 mm towards a neighboring tooth, namely in the region of a proximal contact surface that the dentist/dental technician has previously designed within an accuracy of approximately 25 μm in view of its contact to the surface of the neighboring tooth.

In that case, the dentist has, for example in the chair-side application of the CAD/CAM system directly with the patient, to manually remove the excess material in the region of the proximal contact by means of abrasive tools by approximation, until the inlay can be inserted. Typically, two or more grinding and trial steps are required for this purpose. Both, the dentist and the patient, find this part of the treatment to be unpleasant, and it is time-consuming for both. If not enough material is removed, the restoration jams and the fit in the cavity at its margins and at the occlusal surfaces is inaccurate. If too much material is removed, the contact is lost. In this case the restoration is considered insufficient and has to be made anew.

Also for other types of restorations, such as veneers, partial crows, full crows, and bridges as well as crown and bridge supports, subtractively manufactured veneers and abutments, the manual removal of the material forming the partition pin and extending beyond the level of the anatomic morphologic restorative surfaces or beyond constructed surfaces is an arbitrary manual measure, which can adversely affect the contours of the workpiece or its fit or which can damage critical margin sections.

### DISCLOSURE OF THE INVENTION

By means of the current invention, the fitting of the workpiece manufactured in subtractive manner by means of CAM is to be shortened and made more precise. This is of particular importance for the direct application by the dentist in their practice because there the treatment occurs under time constraints in one go during the session with the patient without intermediate steps carried out by the dental technician.

This problem is solved by the invention defined in the independent claims.

Accordingly, a blank is provided for preparing a dental restoration by means of machining in a machining device. The blank comprises a restoration segment of a machinable tooth restoration material as well as a holder for clamping the blank in the machining device. Further, a partition segment of a material machinable by the machining device is arranged between the holder and the restoration segment. The material of the partition segment differs visually from the tooth replacement material.

“Machinable” material is to be understood as a material that can be shaped in a CAM machining device by means of abrasive machining.

Therefore, a non-restorative section of material, the partition segment, is arranged between the holder and the restoration segment. It differs visually from the interface plane of the restoration segment, advantageously in a visually abrupt manner. This simplifies the exact post-processing of the workpiece in the manner described below.

In particular, the partition segment has a color that differs from the restoration segment. In the present context, the term color not only designates color shade, color saturation, and brightness but also translucence, transparence, and opacity.

The material of the partition segment can differ from the tooth restoration material merely in its pigmentation as long as the two materials can be optically distinguished clearly. The material of the partition segment can, however, also consist of a material different from the dental replacement material, i.e. it can differ from the same not only in its pigmentation but also in its remaining composition. In particular, the restoration segment can be of ceramic and the partition segment of a polymeric material.

Restoration ceramics and polymer-based materials differ strongly in their hardness, such as zirconium oxide ceramics with a Martens hardness (MH) of 7996 as compared to an non-filled polymer with MH 181 (see Mörmann W, Stawarczyk, Ender A, Sener B, Attin Th. Mehl A. “Where characteristics of current aesthetic dental restoration CAD/CAM materials: Two-body wear, gloss retention, roughness and Martens hardness. Journal of the mechanical behavior of biomedical materials 20 (2013) 113-125), in which case they also differ in their ability to be machined. Experience shows that the partition pin of a polymer-based material can be designed to be delicate. This allows to constructively dispense with the broad partition-pin-base in the restoration segment, i.e. on the restoration surface. Such a base has so far been used in the conventional CAM machining of ceramics. In a polymer-based partition pin, the geometrically defined contours of the partition pin can merge into the workpiece formed from the restoration segment at the interface/surface exactly and without enlarging its circumference, such that it can be removed from its surface. The flat interface plane on the restorative workpiece can thereby be reduced to a minimum in an advantageous manner, or it can be adapted with only little manual post-processing to the anatomic morphologic surface.

In the anatomic/morphologic normal case, the interface plane of dental restorations in the row of teeth can advantageously be located in the center of the constructed natural proximal contact. If there are tilted teeth and anatomic irregularities of the neighboring teeth that cannot be corrected plastically, it can happen that the shape of the restoration proximally extends, along the direction of the row of teeth, beyond the constructed contact. In this case, numerically fitting the outer shape of the workpiece into the restoration segment takes account of this and places the outer contour that has the largest extension, in the mesio-distal direction, at the interface plane of the restoration segment.

The partition segment is advantageously glued to the restoration segment and/or the holder because such a connection is constructed in a simple manner. “Glued” is to be understood as a connection created by an originally fluid and then to be hardened adhesive. This can, for example, be a transparent instant glue, a glue, a hot glue, or a solder, in particular a glass-based solder.

The thickness of the partition segment, i.e. its extension in the direction between the holder and the restoration segment, is advantageously at least 0.5 mm, in particular at least 1 mm, such that the machining tool can machine the partition segment. The thickness is advantageously chosen such that there is enough space for the machining tool.

At its upper limit, the partition segment is preferably limited to 3.0 mm such that the pin remaining after the machining is not too long.

Further, the blank can have an optical marker that marks the location for the proximal contact to be generated at the interface plane between the partition segment and the restoration segment. In other words the blank is marked such that, for the user, a defined region of the interface plane is marked in visually perceptible manner. It can be used as a reference surface and for post-processing, in particular for removing the partition segment or for the removal of a partition-pin-base that remains on the restoration segment after eliminating the partition pin.

Advantageously, this marker is located in the core axis of the blank, which forms the machining axis of the restoration segment. Advantageously the core axis even forms the symmetry axis of the whole blank block (wherein any non-symmetrical formations, e.g. in the region of the holders for orienting the blank block in the machining device are ignored).

The marker can be formed by a coloring that is arranged in the partition segment, in the restoration segment and/or at the interface plane. A “coloring” is a local dying of the respective parts. The marker can, for example, be formed by a region that is, in comparison to its surroundings, darker, lighter, differently colored, more transparent, or more opaque.

In particular, the marker can extend, from the interface plane and perpendicular thereto, through at least part of the partition segment and/or of the restoration segment, in particular over a depth of at least 0.1 mm, in particular at least 1 mm. The marker can mark the core axis in the partition segment and the contours of the partition-pin-base in the restoration segment. This makes it possible for the user, during post-processing, to orient himself in the partition segment or in the restoration segment.

In a preferred embodiment, in particular for blanks to be used for posterior teeth, the marker extends through the whole restoration segment. In this case it is advantageously darker than the rest of the restoration segment in order to give the restoration segment a more natural coloring. In this case, the dark/coded marker essentially comes to lie under the mesio-distal central fissure and colors the same in advantageous manner. It is true that the color marker is in that case also visible on the opposite proximal surface, but it cannot be seen there, from the outside, as it is in the contact region within the row of posterior teeth.

In the restoration segment, the contour of the partition-pin-base can be marked in visually perceptible manner in order to simplify the controlled manual, abrasive removal of the partition pin from the anatomize formed surface.

Therefore, advantageously, the marker extends as a zone over a region of a diameter of at least 1 mm in the direction parallel to the interface plane. “As a zone” because it should mark the position of the proximal contact but also the contours of the partition-pin-base.

In order to further characterize the coloring of the restoration, such as a full crown, the central, axial marker in the restoration segment can further be surrounded by several regions of different colors, i.e. by regions that differ from each other and from the marker in their color shade, color saturation, brightness and/or translucence or opacity. In this manner, a workpiece can be manufactured that comes close to the natural appearance of, for example, full crowns in the region of the posterior teeth. The additional color grading can simplify the visual detection of the partition-pin-base that has to be removed.

The partition segment can (in a projection parallel to the core axis) have the same contour as the holder and/or (preferably) as the restoration segment.

The partition segment is advantageously of at least one material comprising glass, plastics, in particular polymers, and ceramics, and it can be transparent, opaque, and or colored. For example, an acrylate polymer can be used.

In contrast to this, the restoration segment is advantageously and at least predominantly of a material of the group comprising ceramics, composites, polymers, and hybrid ceramics. Hybrid ceramics are a network structure of polymer and ceramics. A composite refers to a polymeric resin matrix with inorganic filler bodies.

Polymer-based materials allow, as compared to the more brittle ceramics, advantageous smaller diameters for the partition pin. Therefore, for blanks with a ceramics restoration segment, a polymer or a polymer/-based material is recommended for the partition segment.

A coding can be arranged on or in the partition segment, in particular a coding formed a coloring or by a surface relief (e.g. forming a writing, a barcode, or a QR/code) or by an electronically readable data carrier (e.g. an RF-ID chip).

This coding can, e.g., be read in the machining device. It can be used for identifying the type of the blank, which can, e.g., trigger a machining strategy that is specific for the material or which can be used for detecting, in the device, how the blank can be machined.

The invention further relates to a method for machining such a blank in order to manufacture a dental workpiece. The method comprises the following steps:
Providing a data set describing the outer shape of the workpiece: this data set is obtained by methods known to the skilled person, such as camera in the oral cavity.
Numerically fitting the outer shape of the workpiece into the restoration segment: this fitting, e.g. in the CAD-system, occurs such that at least one flat, advantageously convex, surface of the outer shape comes to lie into the interface plane between the partition segment and the restoration segment, advantageously in tangential manner.
Mechanically removing material of the restoration segment: in this step, the material of the restoration segment is removed up to the numerically fitted outer shape, with the exception of the partition-pin-base around a proximal contact, which guarantees the secure connection to the partition segment during machining. In this phase the restorative workpiece is advantageously held, via the partition pin, by means of the holder in a CAM-machining device. The partition pin originally has a diameter of, e.g., 2 to 3 mm and is continuously reduced towards separation until it breaks.
Removing the (remaining) partition segment from the restoration segment: this can occur, e.g., by means of an abrasive method, by means of chemically dissolving the remaining fragment of the partition pin, by means of burning the fragment of the partition pin, by means of melting the fragment of the partition pin, or by means of splitting the bond between the remaining fragment of the partition pin and the restorative workpiece.
Removing the partition-pin-base around the proximal contact: thereby, the workpiece can, also in this region, be adapted in its shape to the desired outer shape.

Advantageously, a mechanical removal of material from the partition segment occurs, before, after or during the mechanical removal of material from the restoration segment, namely in such a manner that the partition pin between the holder and the mentioned region of the restoration segment remains.

The invention also relates to a machining device for carrying out the method with
an attachment device for attaching the holder of the blank,
at least one abrasive machining tool for machining the restoration element and the partition segment, and
drives for moving the blank and the tool for machining in respect to each other.

Further the device comprises a control adapted to carry out the steps of the method.

The natural proximal contacts are usually formed by convex surfaces of neighboring teeth. The proximal contacts of the posterior teeth are, usually, located somewhat buccally from the central line of the teeth tow and can be located at the border between the middle third and the buccal third of the width of the teeth and between the oral and buccal cusp tips.

Anomalies in the attitude of the teeth and/or in previous restoration work can change the situation, but they can be corrected by preparative plastic treatment of the enamel or of the restoration surfaces of the neighboring teeth.

The process of fitting the outer shape of the workpiece into the restoration segment of the blank starts, as mentioned, numerically, e.g. at the end of the CAD-construction. During this, the exact position can be defined by the user or, advantageously and in order to save time, automatically by means of the software.

The automatic placement is, in particular, possible if the workpiece can be fitted, along the axis of the row of teeth or parallel to the row of teeth, into a, as mentioned, contact situation that conforms, in proximal direction, to the rules. In this case, the partition pin is advantageously positioned in the region of the proximal contact to the neighboring tooth.

If, for example, an inlay with proximal surface is to be manufactured, the contact region of the proximal surface is placed at the interface plane, advantageously at the location where the core axis, as mentioned above, intersects the interface plane.

The central axis of the partition pin advantageously coincides with the core axis of the blank block.

The boundary surface of the proximal contact is then advantageously made to coincide with the interface plane, i.e. the proximal surface is tangential to the interface plane. In this manner the proximal contact surface of the inlay is positioned accurately at the interface of the restoration segment. This interface is, at the same time, made to coincide with the interface of the partition segment. The partition pin is therefore placed, by design, into the partition segment.

The rest of the partition pin that adheres to the proximal surface after cutting or fracturing the partition pin can be ground precisely to the level of the designed proximal contact surface thanks to its visual distinguishing feature.

If the partition segment or the rest of the partition pin is glued to the blank or the restorative workpiece, this rest adhering to the proximal surface can be detached by destroying the adhesion. If the material of the partition segment can be dissolved chemically or can be burned, it can be removed in this manner. For example, the transparent acrylate polymer VITA CAD-Waxx VITA Zahnfabrik), which can be used for the partition segment, can be burned without trace, which can be carried out by a Bunsen burner in a simple manner.

After removing the rest of the partition pin from the restoration segment, the partition-pin-base remains in the mentioned region around the contact point on the restoration segment. It has to be post-processed manually. This partition-pin-base is, so to say, superimposed onto the outer shape of the workpiece.

For example, an inlay can, in this state with the still present partition-pin-base, be tried on in order to test the contact and the fit of the workpiece.

The partition-pin-base is, in particular, adapted by manual grinding to the desired outer shape of the contact-distal proximal surface.

While, for the known blanks, the shaping and machining process starts with grinding at the free end of the restoration segment, the start of the shaping and machining process for the blank according to the invention is, advantageously and depending on the axial position of the restorative workpiece, further within the restoration segment and also shapes the partition pin at the interface to the partition segment into the restoration segment. It is therefore possible to shorten the restoration segment by the axial length of the partition segment.

The blank block can, e.g., be used for manufacturing restorations of silicate ceramics, glass ceramics, translucent zirconium oxide ceramics, composites, polymers and hybrid ceramics. It can also be used to manufacture crowns and bridge constructions and prosthetic bridge constructions with of aluminum oxide ceramics and zirconium ceramics.

### BRIEF DESCRIPTION OF THE DRAWINGS

Further embodiments, advantages and applications of the invention are given in the dependent claims as well as in the now following description with reference to the figures, wherein:

FIG. 1 shows a schematic representation of a dental CAD/CAM blank with an intermediary partition segment between the holder of the block and the restoration segment, and a semi-perspective representation of an inlay CAD-construction for subtractive CAM-manufacturing,

FIG. 2 is a schematic view, from the occlusal side, of an inlay and of the partition pin at the end of the subtractive CAM-milling process with a typical breaking fissure in the partition pin,

FIG. 3 is a schematic partial view, from the occlusal side, from FIG. 2 with the rest of the partition pin on the partition-pin-base of the proximal surface of the inlay,

FIG. 4 is a schematic representation, from the occlusal side, of the partition parts of the blank with the partition segment after the fracture of the partition pin and after detaching the rest of the partition pin from the partition-pin-base on the proximal surface of the inlay with a color coding of the blank extending from the region of the proximal partition-pin-base throughout the block,

FIG. 5 is a schematic view, from the occlusal side, of the CAM-manufactured inlay with the color-coded partition-pin-base still present, wherein the color coding extends longitudinally through the inlay,

FIG. 6 is a schematic view, from the occlusal side, of the inlay inserted into the tooth with the color-coded central contact surface of the proximal contact precisely in the designed position and the still complete partition-pin-base,

FIG. 7 is a schematic representation of the proximal surface with the position of the color-coded central contact surface of the proximal contact accurately according to the design and with the outer boundary lines of the partition-pin-base,

FIG. 8 is a schematic representation of the inlay inserted into the dental cavity with the position of the central proximal contact on the side of the partition pin exactly according to the design, after the controlled abrasive removal of the surrounding parts of the partition-pin-base to the level of the proximal surface,

FIG. 9 is a schematic representation of a blank for the crown of a posterior tooth with a partition segment and with a central color coding extending through the restoration segment starting from the region of the partition-pin-base and, in addition and parallel thereto, surrounding zones of color, translucence and opacity,

FIG. 10 is a further embodiment of the blank block in which the surface on the side of the holder of the restoration segment is accessible for sampling its position, and

FIG. 11 is a machining device for carrying out the method.

### MODES FOR CARRYING OUT THE INVENTION

Dental CAD/CAM Blank Block, Partition Segment

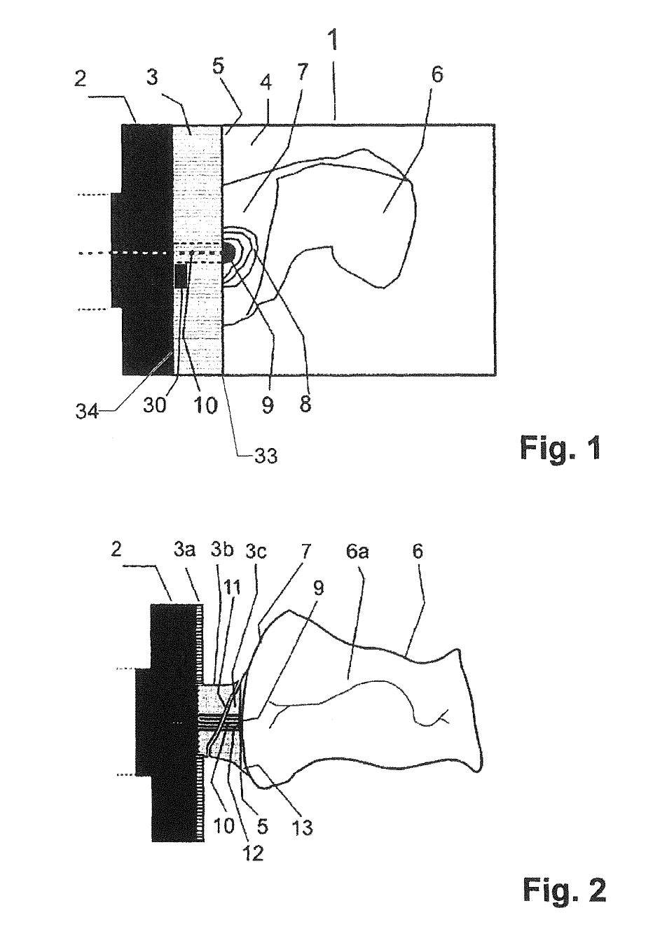

FIG. 1 shows the schematic representation of an embodiment of a dental CAD/CAM blank 1, for manufacturing dental restorations, with a holder 2, a partition segment 3, and a restoration segment 4, which form a mechanical unit and are clamped like this in a machining device (for grinding and/or milling). During this, holder 2 is used for the fixation in the machining device.

The restoration segment 4 consists, e.g., of one of the machinable dental restoration materials mentioned above,known to the skilled person.

Partition segment 3 consists of a partition segment material, e.g. according to one of the examples mentioned above.

Holder 2 consists, e.g., of metal. It forms a rod that can be clamped in the machining device.

The holder 2, the partition segment 3, and the restoration segment 4 are connected to each other at an interface plane 5, e.g. bonded by means of gluing. The respective first adhesive connection between the restoration segment 4 and the partition segment 3 is designated by reference number 33 in FIG. 1, and the second adhesive connection between the holder 2 at the partition segment 3 by reference number 34.

Advantageously the thickness of the adhesive connections 33, 34 is at least 2 μm and/or at most 125 μm.

The adhesive connections 33, 34 advantageously consist of material different from the partition segment. In particular, this allows to better adapt the material for the partition segment to its requirements regarding machinability and stability.

The workpiece to be formed, such as an inlay 6 with three surfaces, is represented in semi-perspective manner with its constructive plan in the block. Its proximal surface 7 with a contact region 8 is shown. In the complete state, the inlay 6 will contact the neighboring tooth in a proximal contact, whose center is designated by reference number 9.

For the shaping step of machining, the data set describing the outer surface of the inlay 6 to be designed, with its contact region 8 and the proximal contact 9 forming the contact center, is numerically brought to coincide with the bounding surface 5 of the restoration segment 4 at the interface plane 5 with the partition segment 3.

The center of proximal contact 9 at the proximal surface 7 of the inlay is preferably positioned to coincide with a core axis 10 in the center of the partition segment 3. The core axis 10 also forms the central axis of restoration segment 4.

FIG. 1 further shows an encoding 30, which, as mentioned, can be a coloring (a print), the surface relief, or an electronically readable data carrier.

FIG. 2 shows, in a schematic representation, a view on the occlusal surface 6a of the inlay 6, which has been formed from the restoration segment 4 by removing material in the CAM process.

The partition segment 2 has been reduced, by means of subtractive machining, to a residual layer 3a on the side of the holder and to a partition pin 3b, 3c. The partition pin 3b, 3c connects the residual layer 3a on the side of the holder with the remaining restoration segment 4.

The partition pin 3b, 3c is broken by “cutting”. FIG. 2 shows a typical fracture line 11 that is formed in this way in occlusal-cervical direction.

The core axis 10 marks, with its core end face 12, the transition to the center of proximal contact 9 on the proximal surface 7 of the inlay.

The adhesive connection 33 at the interface plane 5 provides the adhesion between the rest of the partition pin 3c and the surface of the partition-pin-base 13 on the proximal surface 7 of inlay 6. This partition-pin-base 13 designates the part of restoration segment 4 that is adjacent to the rest 3c of the partition pin and still projects beyond the desired shape of the workpiece to be formed.

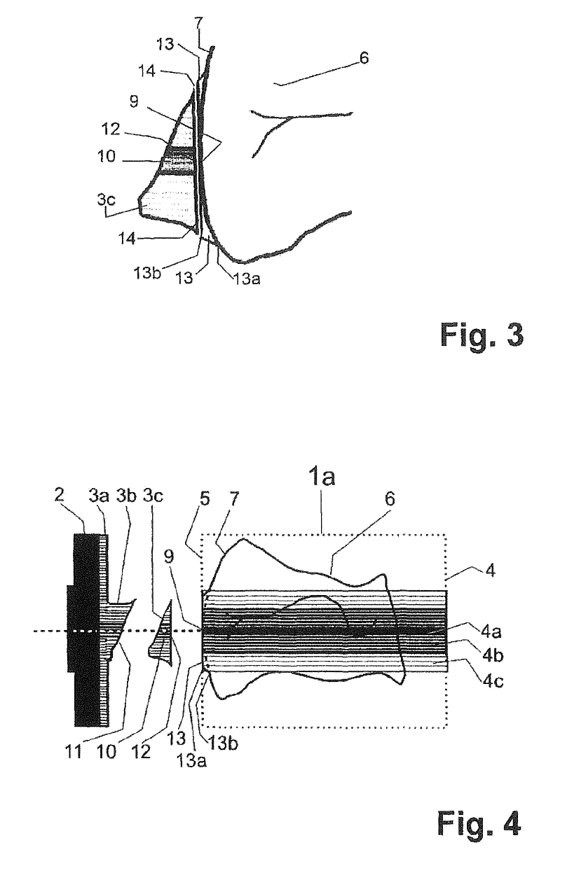

FIG. 3 schematically shows a partial view of inlay 6, from the occlusal side, with the partial contour of the proximal surface 7, on which partition-pin-base 13 formed from the restoration segment 4 carries the rest 3c of the partition pin.

At the interface plane to the glue joint 14, the core axis 10 of the rest 3c of the partition pin is different in color and marks, with its core-end-surface 12, the transition to the proximal contact 9 on the proximal surface 7 of the inlay 6.

The limit points 13a and 13b mark the outer contour, remote from the proximate contact, of the partition-pin-base 13 on the anatomically shaped proximal surface 7 of the workpiece to be manufactured.

FIG. 4 shows separate elements of a blank with: the holder 2, the remaining layer of partition segment 3a, with the fractured stub 3b of the partition pin and the fracture line 11, the rest 3c of the partition pin removed from the restoration segment 4, with the core axis 10, the core end surface 12, the center of the a proximal contact 9, the interface plane or bounding surface 5 of the restoration segment 4, the anatomic contour of the proximal surface 7 of the inlay 6, the inner and outer contour limits 13a and 13b of the partition-pin-base 13.

Further, FIG. 4 shows, as a variant, visually distinguishable color zones 4a, 4b, 4c, which extend over the whole length of the restoration segment 4 starting from the partition-pin-base 13 and the interface plane 5. These color zones are embedded in in the restoration segment 4 of the blank by the manufacturer. They are advantageously symmetrical about the core axis of the blank block 1.

By marking the surface of the partition-pin-base 13 with the color zones 4a, 4b, 4c, the manual, abrasive removal of the partition-pin-base 13 from the anatomic proximal surface 7 between the proximal contact 9 and the outer circumference 13 be can occur in a controlled manner.

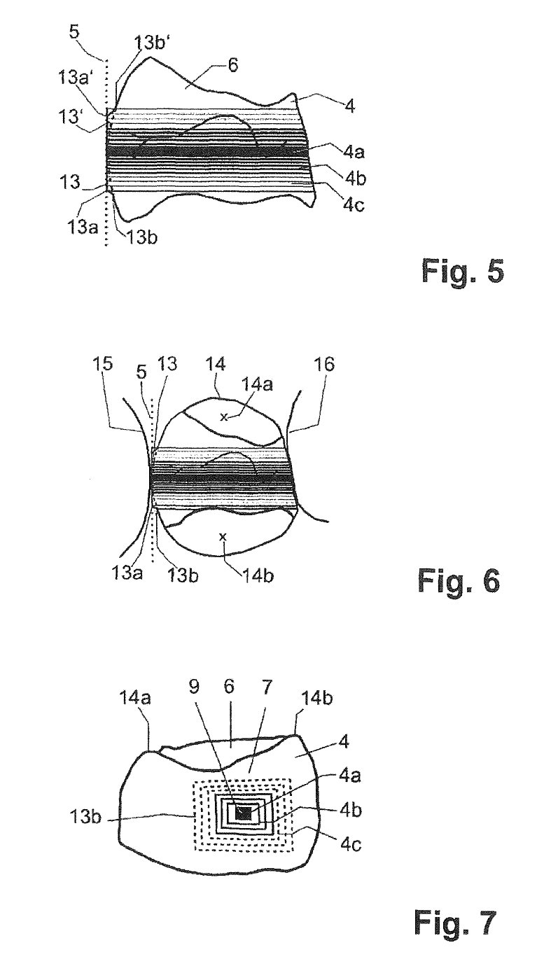

FIG. 5 shows a view, from the occlusal side, of the inlay 6 formed from the restoration segment 4, with the interface plane 5 and the partition-pin-base 13 of the inlay 6 between the inner circumference borders 13a and 13a′ and the outer circumference borders 13b and 13b′, between which the color layers 4a, 4b, and 4c are located.

FIG. 6 schematically shows the inlay inserted into the tooth 14 for trial, with the contours 15 and 16 of the neighboring teeth. The accurately constructed proximal contact is located in the position of the former interface plane 5.

The tips of the oral cusp 14a and the buccal cusp 14b are shown. Usually, the still present partition-pin-base 13 does not interfere with the fit, even though it still projects over the surface as shown by positions 13a and 13b.

FIG. 7 schematically shows the proximal surface 7 of the inlay 6 and the cusps 14a and 14b, i.e. the view of the machined restoration segment 4 along the core axis onto the proximal surface 7.

The outer contour 13b of the partition-pin-base 13 marks the position and size of the partition-pin-base 13 with the central, contacting zone 4a and the color codings 14b and 4c remote from the contact.

The circumference 13b of the base forms an outer limit of the color coding 4c against the material of the rest of the restoration segment 4.

The color-coded regions 4b and 4c remote from the contact and beyond the region 4a can be removed manually and abrasively in a controlled manner using the visual distinction of the color layers.

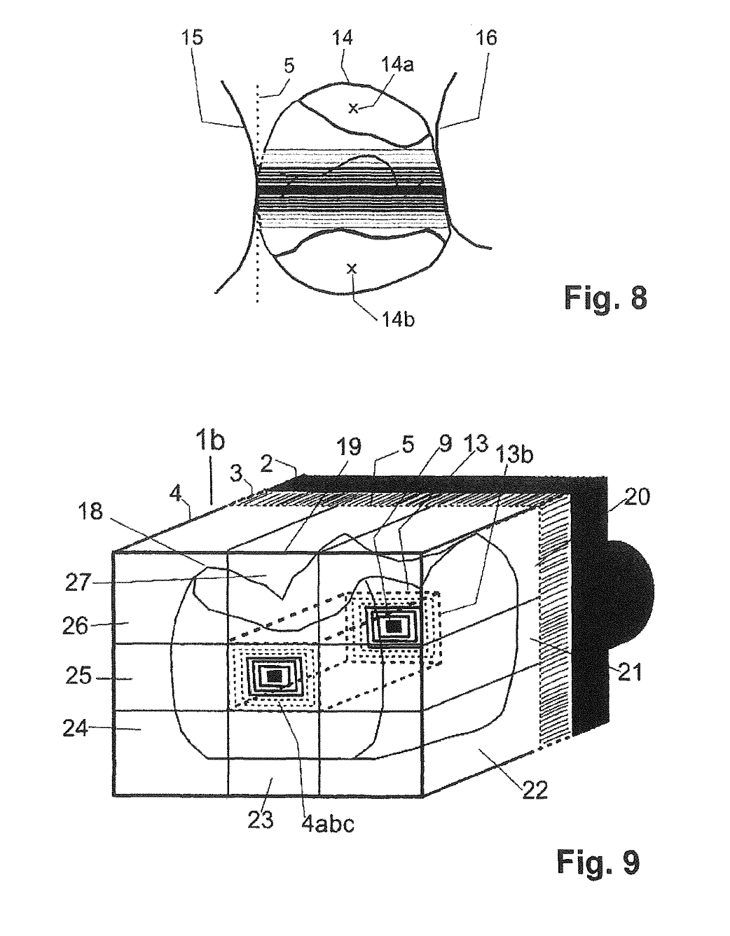

FIG. 8 shows the proximal contact of the inlay in the tooth 14 after removing the partition-pin-base 13, with the neighboring tooth 15 at the position of the previous interface plane 5 between the partition pin 3 and the restoration segment 4. The marking of the tips of the cusps 14a and 14b can be used for orientation.

Below the occlusal surface, the color coding of the previous partition-pin-base extends to the mesial neighboring tooth 16 and serves to tinge the occlusal surface.

FIG. 9 shows the schematic view of a blank 1b for manufacturing a crown in the region of the posterior teeth as seen from the front surface 19 of the restoration segment 4.

The partition segment 3 and the holder 2 are located adjacent to the remote side. The designed external contour of a crown 18 for a posterior tooth is schematically shown in the restoration segment 4.

Again, this crown design is fitted numerically into the restoration segment 4 in such a manner that it touches, according to the method described here, with its proximal contact 9, the interface plane 5 between the restoration segment 4 and the partition segment 3.

The outer contour line 13b designates the border of the contact-free zone of the partition-pin-base 13. The color coding of the partition-pin-base 13 can again extend along the center of the restoration segment 4 along the longitudinal axis of the blank, i.e. the core axis, and the mesio-distal crown axis, all the way to the front surface 19, where it is visible as the core zone 4abc.

In order to polychromatically modify the aesthetics of the crown as compared to monochrome embodiment of the restoration segment 4, the color-coded core zone 4abc can consist of opaque dentin material.

The core zone 4abc can be complemented by means of color zones of different color and brightness, on each side, e.g. as follows.
In the cervical row: dark enamel material 22, dark dentin material 23, dark enamel material 24.
In the central row: medium-shade enamel material on both sides 21, 25 central dentine 4abc.
In the occlusal row: light enamel material on both sides 20, 26, central medium-shade enamel material.

By surrounding with color zones of different levels of color and opacity, the partition pin is visually even more distinct during its manual abrasive removal, and it further allows a polychromatic design of the restoration.

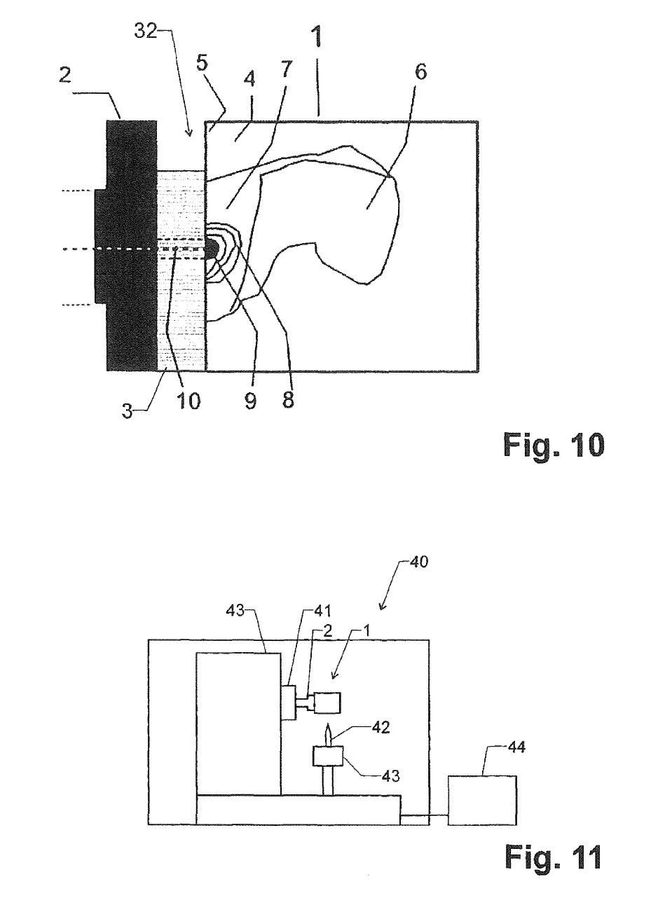

FIG. 10 shows a further embodiment of the blank. In this embodiment, part of the holder-sided (i.e. facing the holder 2) interface plane 5 of the restoration segment 4 is laid open, i.e. not covered by the partition segment 3, and mechanically accessible. This has the advantage that, in a machining device, the position of this interface plane 5 can be measured, which, as mentioned further below, is advantageous while machining the blank.

Such an embodiment is e.g. possible by giving the partition segment 3, in its direction perpendicular to the core axis 10, a smaller diameter than the restoration segment 4, in particular in at least one direction perpendicular to the core axis 10.

It is conceivable, as shown in FIG. 10, for the partition segment 3 to be recessed in at least at one location in order to form a recess 32 between the holder 2 and the restoration segment 4, where the interface plane 5 is accessible for measurement.

Manufacturing

While manufacturing the blank, the partition segment 3 can, for example, first be connected to the holder, by bonding and/or mechanically, and then be glued to the restoration segment 4.

Manufacturing the blank can also occur in a first step by bonding or mechanically connecting the restoration segment 4 with an industrially pre-manufactured transparent and/or colored partition segment 3 of a suitable ceramics, polymeric, composite, hybrid, or glass material, whereupon, in the second step, the blank block is connected, on the side of the partition segment 3, to the holder 2.

Manufacturing the blank block can also be carried out by means of consecutive compression of ceramics granulates by using different colors and/or different transparency as well as opacity, for the restoration segment 4 and the partition segment 3.

If the visually different partition segment 3 and restoration segment 4 are manufactured separately, they can, in particular, be connected to each other by means of glass solder and then, as a blank block (consisting of the partition segment and restoration segment) be glued to the holder 2.

The partition segment 3 can also be manufactured from a non-costly, non-dental separating-segment-material, which has suitable properties for milling and stability.

If a material with suitable elastic module is used, the partition segment 3 can contribute to dampening the vibrations that are generated during machining of the ceramics, to the silent operation of the machining, and to a reduction of the stress of thin material parts

The holder 2 and the partition segment 3 can be formed as an integral part of a single piece if the material fulfills the requirements regarding stability, precise clamping in the milling machine, and machinability at the same time. In this case, the holder is axially extended, in respect to the border surface of the restoration segment, by the thickness of the partition segment.

Alternatively thereto, the holder 2 and the partition segment 3 can be of different materials. For example, the holder 2 can be of a metal.

Machining

Machining of the blank occurs, as mentioned, in a machining device, which has at least one abrasive tool for abrasively machining the blank. For manufacturing the workpiece, the respective method executes the following steps:
Providing a data set defining an outer shape of the workpiece,
Numerically fitting the outer shape into the restoration segment 4 such that a surface of the outer shape comes to lie in a contact, in particular a proximal contact 9, in an interface plane 5 between the partition segment 3 and the restoration segment 4.
Mechanically removing material of the restoration segment 4 up to the fitted outer shape, with the exception of a partition-pin-base around the proximal contact 9,
Removing the partition segment 3 from the restoration segment 4, and
Machining the restorative workpiece 6 in said partition-pin-base.

Advantageously, the position of the holder-side interface plane 5 of the restoration element 4 is sampled in the machining device, namely the position in the direction of the core axis 10. For this purpose, interface plane 5 should, as mentioned above, be mechanically accessible. The measurement of this position is advantageous because it allows to position the outer shape of the workpiece more accurately at the interface plane 5, thus the outer shape can be fitted precisely into the restoration segment. The machining errors of the partition segment 3 and the adhesive connections 33, 34 are eliminated by means of this calibration.

Sampling the position of the holder-sided interface plane 5 is advantageously carried out by driving a machining tool of the machining device, from the side of the holder 2 against the interface plane 5 until a mechanical contact occurs. The position of the tool upon this contact defines the position of the interface plane 5.

A machining device 40 for carrying out the method is shown in FIG. 11. It has an attachment device 41 at which the holder 2 of the blank 1 can be attached, at least one abrasive machining tool 42 for machining the restoration element 4 and the partition segment 3. Further, drives 43 are provided for moving, during machining, the blank 1 and the tool 42 in respect to each other.

The machining device 40 further comprises a control unit 44, which (e.g. by means of suitable control programs) is adapted to carry out the steps of the described machining method by controlling the components of the machining device 40 accordingly.

Notes

As mentioned, the partition segment 3 can have the same circumference as the holder 2 and/or the restoration segment 4. Alternatively, the partition segment 3 can, in a direction perpendicular to the core axis 10, also have a smaller diameter than the restoration segment 4.

In this manner, the time for machining the partition segment 3 can be reduced or even eliminated.

The partition segment 3 can consist of any material that differs from the restoration segment 4 in its color and/or opacity and translucence which, if applicable, fulfills the requirements for a precise subtractive machining and stability of the material used in the restoration segment.

The adhesive bonding compound (adhesive, e.g. glass solder) between the restoration segment 4 and the partition segment 3 of the blank differs advantageously in its color from the restoration segment 4 as well as from the partition segment 3, e.g. by being colored with strong pigments. In this way, the interface plane between the two segments is marked and processing is made easier.

While, in the present application, preferred embodiments of the invention are described, it is to be pointed out that the invention is not limited thereto and can also be carried out in different manner within the scope of the following claims.

1. A blank for preparing a dental restoration by means of automated abrasive machining in a machining device, wherein the blank comprises a restoration segment of a machinable tooth replacement material as well as a holder for clamping the blank in the machining device, wherein a partition segment of a machinable partition segment material is arranged between the holder and the restoration segment, wherein the partition segment material differs visually from the tooth replacement material.

2. The blank of claim 1 wherein the partition segment material differs from the tooth replacement material in its pigmentation only.

3. The blank of claim 1 wherein the partition segment material is of a material different from the tooth replacement material, and in particular wherein the restoration segment is of a ceramic and the partition segmenter of a polymeric material.

4. The blank of claim 1 wherein the partition segment is glued to the restoration segmenter and/or the holder.

5. The blank of claim 1 comprising an optical marker, which marks a location of a proximal contact to be generated at an interface plane between the partition segment and the restoration segment.

6. The blank of claim 5 wherein the marker is located in a core axis of the blank, which core axis forms a symmetry axis of the restoration segment, in particular of a whole blank.

7. The blank of any of claim 5 wherein the marker is formed by a coloring arranged in the partition segment, in the restoration segment and/or at the interface plane.

8. The blank of claim 5 wherein the marker extends, perpendicularly to the interface plane, from the interface plane through at least a part of the partition segment and/or the restoration segment, in particular over a depth of at least 0.1 mm, in particular of at least 1 mm.

9. The blank of claim 8 wherein the marker extends through the whole restoration segment, and in particular wherein the marker is darker than a rest of the restoration segment.

10. The blank of claim 9 wherein the marker is surrounded, in the restoration segment, by several regions of different colors.

11. The blank of claim 5, wherein the marker extends as a zone over a region having a diameter of at least 1 mm parallel to the interface plane.

12. The blank of claim 1 wherein the partition segment has a same contour as the holder and/or the restoration segment.

13. The blank of claim 1 wherein the partition segment is of a material comprising glass, plastics, in particular polymers, and ceramics.

14. The blank of claim 1 wherein the holder and the partition segment are of a single piece.

15. The blank of claim 1 wherein a coding is arranged on or in the partition segment, in particular a coding formed by a coloring, a surface relief and/or an electronically readable data carrier.

16. The blank of claim 1 wherein an adhesive bonding medium provided at an interface plane between the restoration segment and the partition segment differs in color from the restoration segment as well as from the partition segment.

17. The blank of claim 1 wherein the partition segment has a color different from the restoration segment.

18. The blank of claim 1 wherein a first adhesive connection is arranged between the partition segment and the restoration segment and/or wherein a second adhesive connection is arranged between the partition segment and the holder.

19. The blank of claim 18 wherein the first and/or the second adhesive connection is of a material different from the partition segment.

20. The blank of claim 18 wherein the first and/or the second adhesive connection has a thickness of at least 2 μm and at most of 125 μm.

21. The blank of any claim 1 wherein a thickness of the partition segment along a direction between the holder and the restoration segment is at least 0.5 mm, in particular at least 1 mm, and/or no more than 3.0 mm.

22. The blank of claim 1 wherein a part of a holder-sided interface plane of the restoration element is mechanically accessible.

23. The blank of claim 1 wherein the partition segment has, in a direction perpendicular to a core axis of the blank, a smaller diameter than the restoration segment.

24. The blank of claim 1 wherein the partition segment is set back at least at one location in order to form a recess between the holder and the restoration element.

25. A method for machining a blank for manufacturing a workpiece, wherein said blank comprises
a restoration segment of a machinable tooth replacement material,
a holder for clamping the blank in a machining device,
a partition segment of a machinable partition segment material arranged between the holder and the restoration segment, wherein the partition segment material differs visually from the tooth replacement material and wherein the holder and the partition segment are of a single piece,
wherein said method comprises the steps of:
providing a data set describing an outer shape of the workpiece,
numerically fitting the outer shape of the workpiece into the restoration segment such that a surface of the outer shape comes to lie, at a contact, in particular a proximal contract, in an interface plane between the partition segment and the restoration segment,
mechanically removing material from the restoration segment up to the outer shape, excluding a partition-pin-base around the contact or proximal contact,
removing the partition segment from the restoration segment,
machining the workpiece at said partition-pin-base.

26. The method of claim 25 wherein before, after or during mechanically removing material from the restoration segment, a mechanical removal of material from the partition segment occurs as well, namely such that a partition pin forms between the holder and the partition-pin-base of the restoration segment.

27. The method of any of claim 25, wherein the removal of at least part of the partition segment occurs by means of chemically dissolving the partition segment, by means of burning the partition segment, by means of melting the partition segment, splitting a bond between the partition segment and the restoration segment.

28. The method of any of claim 25 wherein a position of a holder-sided interface plane of the restoration element is sampled in order to fit the outer shape into the restoration segment.

29. A machining device for carrying out the method of claim 25 with
an attachment device for attaching the holder of the blank,
at least one abrasive machining tool for machining the restoration element and the partition segment,
drives for moving, during machining, the blank and the tool in respect to each other,
a control unit adapted to carry out the steps of the method.

30. A method for machining a blank for manufacturing a workpiece, wherein said blank comprises
a restoration segment of a machinable tooth replacement material,
a holder for clamping the blank in a machining device,
a partition segment of a machinable partition segment material arranged between the holder and the restoration segment, wherein the partition segment material differs visually from the tooth replacement material and wherein the holder and the partition segment are of a single piece,
wherein said method comprises the steps of the steps of:
providing a data set describing an outer shape of the workpiece,
numerically fitting the outer shape of the workpiece into the restoration segment such that a surface of the outer shape comes to lie, at a contact, in particular a proximal contract, in an interface plane between the partition segment and the restoration segment,
mechanically removing material from the restoration segment up to the outer shape, excluding a partition-pin-base around the contact or proximal contact,
removing the partition segment from the restoration segment,
machining the workpiece at said partition-pin-base.
